(19) United States
(12) Patent Application Publication
(10) Pub. No.: US 2016/0085073 A1
(43) Pub. Date: Mar. 24, 2016

(54) SEMITRANSPARENT MONOCULAR VIEWING SYSTEM

(71) Applicant: THALES, Courbevoie (FR)

(72) Inventors: Philippe CONI, Saint Jean d'Illac (FR); Laurent Laluque, Bordeaux (FR); Xavier Servantie, Pessac (FR)

(21) Appl. No.: 14/862,110

(22) Filed: Sep. 22, 2015

(30) Foreign Application Priority Data
Sep. 22, 2014 (FR) 1402112

(51) Int. Cl. G02B 27/01; G02B 27/22; B64D 45/00; G02B 27/26

(52) U.S. Cl. CPC G02B 27/0172; G02B 27/0179; G02B 27/26; G02B 27/2207; G02B 27/2264; B64D 45/00; G02B 2027/0185; G02B 2027/0178; G02B 2027/0134; G02B 2027/0183

(57) ABSTRACT

The field of the invention is that of viewing systems comprising means for generating images of a preset object and a viewing device comprising a semitransparent projection screen on which said images are formed. The viewing system according to the invention comprises a piece of eyewear comprising two eyeglasses, the first eyeglass transmitting said images and the second not transmitting them, both eyeglasses transmitting the exterior landscape. The first eyeglass may be passively obturated via spectral selection or polarization or actively via sequential selection.

The field of the invention is that of viewing systems allowing an image to be superposed on the outside world. The technical applications are mainly in vehicular piloting/driving assistance systems. The invention more particularly applies to the field of aircraft cockpits in which the pilot needs to see the exterior and simultaneously view aircraft flight and navigation data. The invention may also be applied to any piloting/driving or control system displaying symbols in superposition on a natural exterior environment. This is the case, for example, of control towers or ship helm stations. The exterior environment may also be simulated. This is the case of driving simulators or drone command/control platforms.

In the field of aeronautics or in neighbouring technical fields, there exist a certain number of viewing devices allowing this function to be carried out, these devices are also known as “see-through displays”.

The simplest way to superpose a digital image on a landscape consists in projecting or forming the image on a semitransparent screen placed in front of the pilot(s) or driver(s). This solution has the advantage of making it possible to cover a large area and to produce an image in a large visual field in contrast to collimated viewing systems the pupil of which, by nature, is necessarily limited.

However, by its very nature, the projected image is at finite distance whereas the landscape is, generally, at great distance. The superposition on the exterior is therefore not perfect. Specifically, either the pilot accommodates on the projected image and the exterior landscape doubles and is seen to be slightly blurred, or the pilot accommodates on the exterior landscape and it is the projected image that, this time, doubles and is seen blurred. This change in accommodation is the source of substantial or even debilitating ocular fatigue.

The system according to the invention does not have these drawbacks. Specifically, it privileges the image of the exterior landscape which is seen binocularly whereas the image originating from the projector is seen monocularly. More precisely, the subject of the invention is a viewing system comprising means for generating images of a preset object and a viewing device comprising a semitransparent projection screen on which said images are formed, characterized in that the viewing system comprises a piece of eyewear comprising two eyeglasses, the first eyeglass transmitting said images and the second not transmitting them, both eyeglasses transmitting the exterior landscape.

Advantageously, the system comprises means for detecting the relative position of said piece of eyewear relative to the position of the semitransparent screen and means for calculating the images so that the position of the image of the preset object remains immobile in a preset coordinate system.

Advantageously, the viewing device functions in a polarized mode, the piece of eyewear comprising a first eyeglass having a first polarization and a second glass having a second polarization different from the first polarization, the images being emitted with the first polarization.

Advantageously, the images are emitted at one and only one wavelength, the first eyeglass comprising a filter transmitting the spectrum in its entirety except for a narrow first spectral band centred on said first wavelength.

Advantageously, the images are emitted in three different spectral bands, the first eyeglass comprising a filter transmitting the spectrum in its entirety except for said three spectral bands.

Advantageously, the viewing device functions in a sequential mode, the images being emitted in alternation, the piece of eyewear comprising means arranged so that the transparency of the first eyeglass of the piece of eyewear varies from transparent to opaque synchronously with the emission of said images, the first eyeglass being opaque when the images are emitted.

Advantageously, the viewing system is an aircraft cockpit system.

The invention will be better understood and other advantages will become apparent on reading the following nonlimiting description and by virtue of the appended figures, in which:

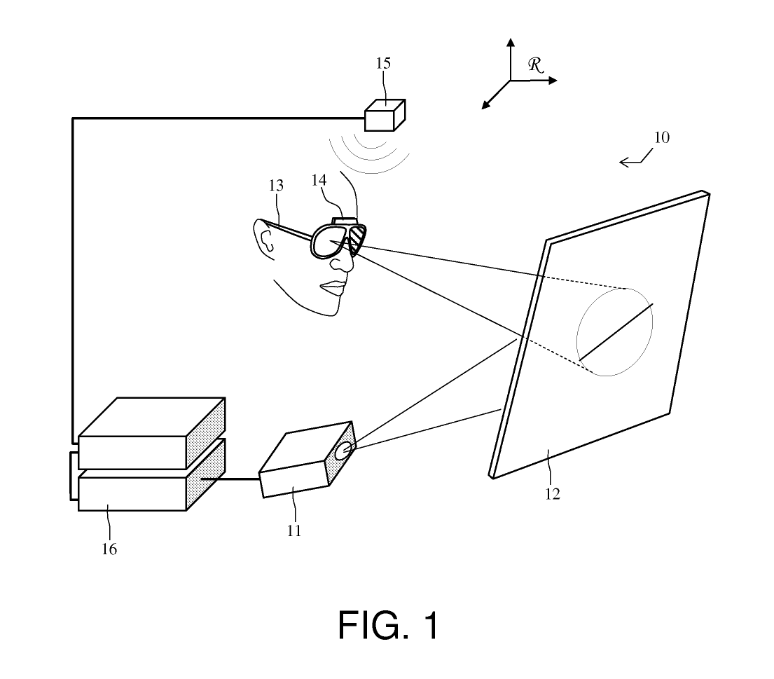

FIG. 1 shows a first architecture of a viewing system according to the invention dedicated to a single observer; and

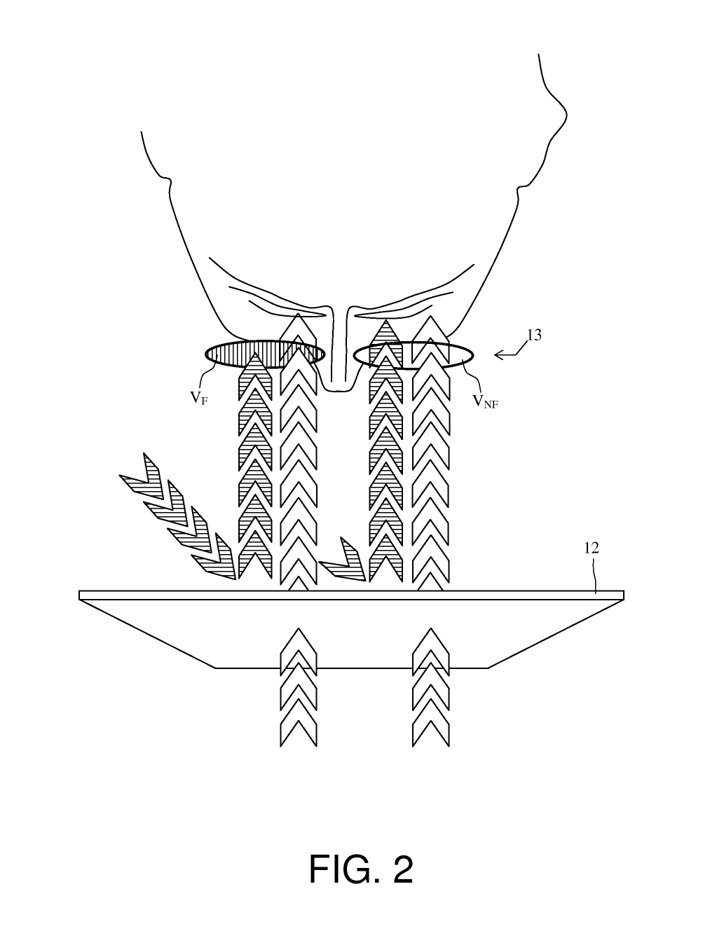

FIG. 2 shows the operating principle of the piece of eyewear according to the invention.

By way of example, a viewing system according to the invention is shown in FIG. 1. It essentially comprises:
a projector 11 of images capable of generating an image representative of an object and intended to be perceived by a single eye. In the case in FIG. 1, the object is a barred circle;
a scattering semitransparent screen 12 onto which said images are projected;
a piece of eyewear 13 comprising a first eyeglass transmitting said image and a second eyeglass not transmitting it, the two eyeglasses transmitting the exterior landscape, and first detecting means 14, said piece of eyewear 13 being intended to be worn by a user;
second detecting means 15 associated with a fixed coordinate system [symbol] and that, in combination with the first detecting means 14, allow the spatial position of the piece of eyewear 13 in this fixed coordinate system to be detected; and
an electronic processor 16 performing at least the following functions:
acquisition of signals issued from the detecting means 14 and/or 15 and calculation of the position of the piece of eyewear;
calculation of the position of the image corresponding to the position of the piece of eyewear; and
calculation of said image.

The projector 11 of stereoscopic images comprises a high-resolution display generally of small size and projection optics having a magnification that may be substantial. For aeronautical applications, it is important for the maximum luminance of the display to be able to be very high. The images are coded by the display so as to be able to be viewed via a single of the two eyeglasses of the piece of eyewear 13.

The semitransparent screen 12 is an optical plate that not only is semitransparent to the exterior landscape but also scatters the stereoscopic images. To this end, the surface of the projection screen may comprise an array of scattering patterns. The screen is scattered over a wide viewing angle, approximately the half-space. Thus a large eye box is obtained. The expression “eye box” is understood to mean the region of space in which the image is visible. This solution also makes it possible to perfectly control the transparency of the screen. Thus, if the patterns cover only a limited percentage of the surface of the screen, the transmission of the screen is equal to unity minus the percentage covered by the patterns. For example, if the patterns cover 20% of the surface, the transmission of the screen is approximately 80%.

The function of the piece of eyewear 13 is schematically shown in FIG. 2. The exterior landscape is represented by a series of white chevrons and the image originating from the projector by a series of hatched chevrons.

The piece of eyewear 13 comprises an eyeglass V_{F} that completely filters the image originating from the projector but that lets pass, albeit partially, the exterior landscape. The second eyeglass V_{NF} lets both the exterior landscape and the digital image pass.

Various means exist that allow an image to be transmitted or not transmitted while retaining a certain transmission of the exterior.

In a first technical solution, the projector functions in a polarized mode and it emits an image with a set polarization. The piece of eyewear 13 comprises a first eyeglass polarized opaque to the set polarization and a second eyeglass polarized transparent to said polarization. This solution has the advantage of requiring only a passive piece of eyewear. However, preservation of the polarization by the semitransparent screen requires non-scattering patterns to be employed.

In a second technical solution, the projector functions in a sequential mode and emits images in succession and periodically. The piece of eyewear comprises a first eyeglass that remains transparent during the sequences of emission of the images and a second eyeglass that remains opaque during said sequences. During the sequences in which the images are not emitted by the projector, both eyeglasses are transparent. It is thus easily possible to regulate the transmission of the exterior landscape by using different image emission and non-emission durations. The variations in transmission of the eyewear eyeglasses are obtained using, for example, active liquid-crystal eyeglasses or mechanical microswitches, which are also known as “shutters”.

In a third technical solution, a spectral selection is carried out on the projected images. The projector emits a coloured image the spectrum of which is determined. The piece of eyewear comprises a first eyeglass comprising a spectral filter that blocks said spectrum and the second eyeglass does not comprise this filter.

The image may be monochromatic or coloured. In the case of a monochromatic image, it is advantageous to use a spectral band the width of which is the smallest possible for example by using a source of laser illumination so that the filter cuts off a spectral band of very small width, not exceeding a few nanometres. Thus, the transmission of the exterior landscape is hardly affected at all. Production of such narrow-band cut-off filters does not pose any particular production problems.

The system for detecting the position of the piece of eyewear is not essential to the invention. Specifically, the function of this system is to locate the piece of eyewear in space and to deduce therefrom, knowing its position, the position of the projected image so that it appears stationary in a given coordinate system. It will be understood that, for a certain number of applications, it is not necessarily useful for this function to be present. For example, it is not absolutely necessary for flight data to be displayed in a set direction. In contrast, a certain number of symbols or images must be perfectly superposed on the exterior. These symbols are said to be conformal, i.e. they appear to the user in the direction and at the angle at which they would appear if they were actually in the landscape. In the latter case, the system for detecting the position of the piece of eyewear is indispensable.

This detecting system conventionally comprises two subassemblies, the first subassembly 14 is fastened to the piece of eyewear and the second subassembly 15 is placed in a fixed coordinate system.

There are various techniques allowing an object to be located in space. It is possible to use electromagnetic detection. An emitter is placed in the fixed coordinate system and a receiver in the mobile coordinate system. It is also possible to use optical detection which may be passive or active. In the latter case, the piece of eyewear has light-emitting diodes the position of the emission of which is located by cameras. All these techniques are known to those skilled in the art. They are compatible with operation in real-time and are easily adaptable to the viewing system according to the invention.

The viewing system then operates as follows. When the user moves his head, these movements are sensed by the detecting means of the piece of eyewear. The electronic processor then recalculates in real-time the position of the images so that the user continues to see the virtual image of the object in the same place.

The system according to the invention is most particularly applicable to the field of aircraft cockpits in which the pilot needs both to see the exterior and to view aircraft flight and navigation data without having problems with accommodation that may prove to be highly disadvantageous. The application to the field of helicopters is of particular interest insofar as helicopters possess large windows and are required to carry out flights at low altitudes.

1. A viewing system comprising means for generating images of a preset object and a viewing device comprising a semitransparent projection screen on which said images are formed, wherein the viewing system comprises a piece of eyewear comprising two eyeglasses, the first eyeglass transmitting said images and the second not transmitting them, both eyeglasses transmitting the exterior landscape.

2. The viewing system according to claim 1, wherein the system comprises means for detecting the relative position of said piece of eyewear relative to the position of the semitransparent screen and means for calculating the images so that the position of the image of the preset object remains immobile in a preset coordinate system.

3. The viewing system according to claim 1, wherein the viewing device functions in a polarized mode, the piece of eyewear comprising a first eyeglass having a first polarization and a second glass having a second polarization different from the first polarization, the images being emitted with the first polarization.

4. The viewing system according to claim 1, wherein the images are emitted at one and only one wavelength, the first eyeglass comprising a filter transmitting the spectrum in its entirety except for a narrow first spectral band centred on said first wavelength.

5. The viewing system according to claim 1, wherein the images are emitted in three different spectral bands, the first eyeglass comprising a filter transmitting the spectrum in its entirety except for said three spectral bands.

6. The viewing system according to claim 1, wherein the viewing device functions in a sequential mode, the images being emitted in alternation, the piece of eyewear comprising means arranged so that the transparency of the first eyeglass of the piece of eyewear varies from transparent to opaque synchronously with the emission of said images, the first eyeglass being opaque when the images are emitted.

7. The viewing system according to claim 1, wherein the viewing system is an aircraft cockpit system.
